(19) United States
(12) Patent Application Publication
(10) Pub. No.: US 2010/0011605 A1
(43) Pub. Date: Jan. 21, 2010

(54) Clothes dryer

(76) Inventors: Min-Ji Kim, Changwon (KR); Sang-Hun Bae, Changwon (KR); Chul-Jin Choi, Changwon (KR)

Correspondence Address: MCKENNA LONG & ALDRIDGE LLP, 1900 K STREET, NW, WASHINGTON, DC, 20006, US

(21) Appl. No.: 12/458,556

(22) Filed: Jul. 15, 2009

Related U.S. Application Data
(60) Provisional application No. 61/129,779, filed on Jul. 17, 2008.

(30) Foreign Application Priority Data
Jul. 17, 2008 (KR) 10-2008-0069728

(51) Int. Cl. F26B 19/00; D06F 58/04

(52) U.S. Cl. 34/60; 34/108; 34/88

(57) ABSTRACT

A clothes dryer includes: a main body constituting an outer appearance; a drum rotatably installed within the main body; a front supporter supporting the drum at a front side; and a fragrance supply device configured to supply fragrance to the interior of the drum, wherein the fragrance supply device includes a liquid level detecting unit for detecting a liquid level of a fragrance liquid stored therein. The fragrance supply device includes a liquid level detecting unit. The liquid level detecting unit includes an electrode sensor installed in the chamber, a magnet attached to a floater, and a reed switch. With the presence of the liquid level detecting unit, when the fragrance liquid stored in the chamber is used up so it needs to be supplemented, the user can easily recognize that upon viewing an indication displayed on a control panel or the like.

### RELATED APPLICATION

The present disclosure relates to subject matter contained in priority Korean Application No. 10-2008-0069728, filed on Jul. 17, 2008, and U.S. Patent Application No. 61/129,779, filed on Jul. 17, 2008 which are herein expressly incorporated by reference in its entirety.

### BACKGROUND OF THE INVENTION

1. Field of the Invention

The present invention relates to a clothes dryer and, more particularly, to a clothes dryer including a fragrance supply device for spraying fragrance into a drum of the clothes dryer and a unit for detecting the capacity of fragrance stored in the fragrance supply device.

2. Description of the Related Art

In general, a clothes dryer is a device for inputting the laundry in a spin-dry-terminated state after washing is completed into the interior of a drum and supplying hot wind into the drum to evaporate moisture of the laundry to thus dry the laundry.

The clothes dryer includes a drum into which the laundry is input, a driving motor for driving the drum, a blow fan for blowing air into the interior of the drum, and a heating unit for heating air introduced into the interior of the drum.

The heating unit may use high temperature electric resistance heat generated by using an electric resistance or combustion heat generated by combusting (burning) gas.

Air discharged from the drum in the clothes dryer contains moisture of the laundry placed within the drum, so the air includes much moisture and has high temperature. In this case, the dryer may be classified into according to how the air with much moisture at a high temperature is processed. Namely, the driver may be classified into a condense type drier in which air with high temperature and high moisture is circulated, rather than being discharged to the outside, to be heat exchanged with external air in a condenser to condense the moisture contained in the air with the high temperature and high moisture, and an exhaust type dryer in which air with the high temperature and high moisture, which has passed through the drum, is directly discharged outwardly.

In the related art dryer, the laundry are spin-dried in a state of being tightly attached to an inner circumferential surface of the drum during a spin-dry process, so in order to remove creases of the laundry and return the laundry into a state in which the laundry is suitably ironed out, a device for supplying steam into the interior of the drum of the dryer.

However, after washing is completed, when the laundry is input into and dried in the dryer, moisture contained in the laundry is removed, but the dried laundry may smell of washing water or a detergent, or the odor of the clothes before being washed may not be completely removed but remain even after the dry operation is completed, to cause user inconvenience. Thus, in order to remove such smell and make the user feel good, fragrance was supplied to the interior of the drum.

However, because a means for easily detecting a state that the fragrance stored in a device for supplying fragrance to the interior of the drum is used up is not provided, although a fragrance liquid has been completely consumed, the user cannot recognize it. Thus, even if fragrance does not emanate during a fragrance dry process, the user cannot know the amount of the fragrance liquid stored in the fragrance supply device.

### SUMMARY OF THE INVENTION

Therefore, in order to address the above matters, the various features described herein have been conceived.

An object of the present invention provides a unit for detecting the amount of a fragrance liquid stored in a fragrance supply device.

Another object of the present invention provides a unit for detecting a liquid level of a fragrance liquid in case where a stored fragrance liquid is in a liquid state.

According to an aspect of the present invention, there is provided a clothes dryer including: a main body constituting an outer appearance; a drum rotatably installed within the main body; a front supporter supporting the drum at a front side; and a fragrance supply device configured to supply fragrance to the interior of the drum, wherein the fragrance supply device includes a liquid level detecting unit for detecting a liquid level of a fragrance liquid stored therein.

With such configuration, the liquid level of the fragrance liquid can be detected, so the user can supply to supplement the fragrance liquid to a fragrance liquid storage space as necessary.

The fragrance supply device includes: a chamber in which the fragrance liquid is stored; a pump connected to the chamber; and a nozzle connected to the pump and jetting (i.e., spraying, injecting, etc.) fragrance to the interior of the drum, wherein a fragrance liquid stored in the chamber is introduced to the nozzle through the pump and jetted in a form of mist to the interior of the drum of a dryer from the nozzle.

The liquid level detecting unit includes electrode sensors installed in the chamber, whether or not the electrode sensors are put in the fragrance liquid, they are determined to be electrically connected, based on which the liquid level of fragrance liquid can be determined.

The electrode sensors include a first electrode sensor installed at a lower portion of the chamber and a second electrode sensor, and in this case, the second electrode sensor is installed to be lower than the first electrode sensor. The electrode sensors may further include a third electrode sensor installed at an upper portion of the chamber to detect a high liquid level of the fragrance liquid.

The liquid level detecting unit may include: a floater ascending or descending according to the liquid level of the fragrance liquid in the chamber; a magnet installed on the floater and generating a magnetic force; and a reed switch for detecting the magnetic force generated from the magnet installed on the floater.

A guiding unit may be provided at the chamber to guide ascending and descending of the floater. The reed switch may be installed at a lower portion of an outer surface of the chamber. The reed switch may include a first reed switch installed at the lower portion of the outer surface of the chamber to detect a low liquid level of the fragrance liquid and a second reed switch installed at an upper portion of the outer surface of the chamber to detect a high liquid level of the fragrance liquid.

The clothes dryer may further include: a controller configured to determine a liquid level of the fragrance liquid upon receiving information about a liquid level detected by the liquid level detecting unit; and a display unit configured to display whether or not the liquid level of the fragrance liquid is proper upon receiving a signal from the controller.

The display unit may be formed on a control panel of the main body and have a lamp for indicating a normal liquid level, a high liquid level, and a low liquid level.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is perspective view of a clothes dryer according to an exemplary embodiment of the present invention;

FIG. 2 is a side sectional view of the clothes dryer of FIG. 1;

FIG. 3 is a perspective view of a steam generator mounted at the clothes dryer;

FIG. 4 illustrates a front supporter including a fragrance supply device according to an exemplary embodiment of the present invention;

FIG. 5 is a perspective view of the fragrance supply device of FIG. 4;

FIG. 6 is a perspective view of a chamber having electrode sensors in the fragrance supply device; and

FIG. 7 is a perspective view of the chamber including a floater and a reed switch in the fragrance supply device.

### DETAILED DESCRIPTION OF THE INVENTION

The clothes dryer according to an exemplary embodiment of the present invention will now be described in detail with reference to the accompanying drawings.

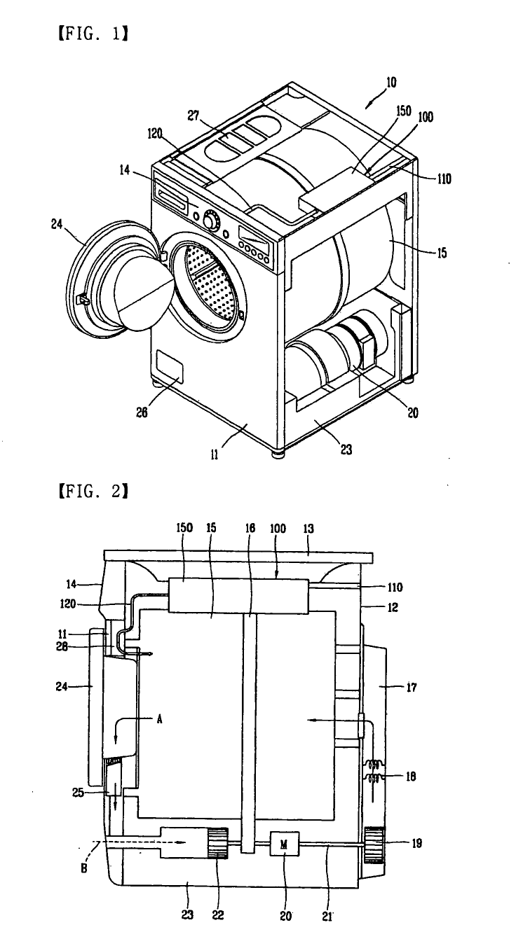

With reference to FIGS. 1 and 2, a clothes dryer 10 includes a front cover 11, a rear cover 12 and a top cover constituting an outer appearance of the clothes dryer 10, and a drum 15 into which the laundry is input. The clothes dryer 10 also includes a front supporter 28 mounted on a rear surface of the front cover 11 and supporting a front opening of the drum 15, a door 24 mounted on a front surface of the front cover 11 and opening and closing the opening of the drum 15, and a control panel 14 provided on an upper side portion of the front cover 11 and having various buttons for inputting dry conditions.

The clothes dryer 10 further includes a dry fan 19 for circulating air within the drum 15 to be circulated in the clothes dryer 10, a dry duct 17 for guiding a flow of the circulated air such that the circulated air which has passed through the dry drum 15 by means of the dry fan 19 to be introduced again to the interior of the drum 15, a heater 18 mounted at an inner side of the dry duct 17 and increasing the temperature of the air introduced into the drum 15, and a steam generator 100 mounted at one outer side of the dry drum 15 and generating steam.

At a lower side of the drum 15, there are formed a base 23 including a flow path of the circulated air (A) and flow path of external air (B) for being heat-exchanged with the circulated air, a driving motor 20 mounted at an upper portion of the base 23 and driving the drum 15, a belt 16 for transferring a rotational force generated by the driving motor 20 to the drum 15, a cooling fan 22 connected to a motor shaft 21 of the driving motor 20 and sucking indoor air, and a condenser 26 mounted at one side within the base 23 and allowing indoor air to be heat-exchanged with the circulated air.

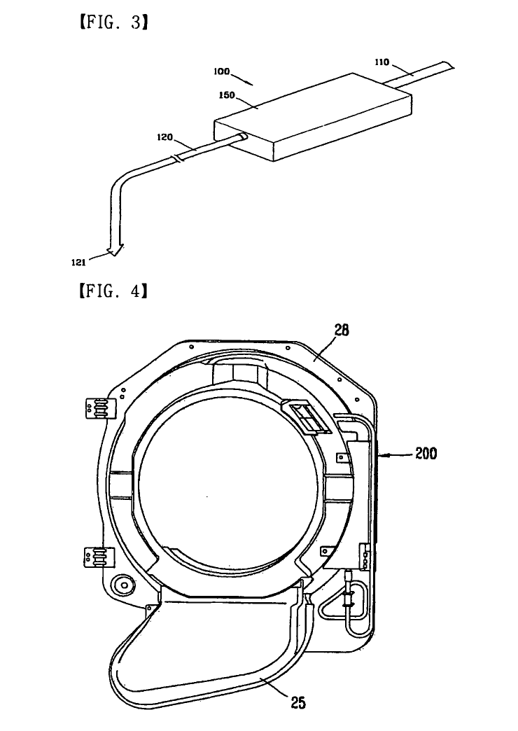

FIG. 3 is a perspective view of a steam generator mounted at the clothes dryer. The steam generator 100 includes a water supply hose 110 for supplying water at the room temperature, a steam generator body 150 for storing supplied water, a heater (not shown) provided within the steam generator body 150 and heating stored water, a discharge hose 120 along which steam generated from the steam generator body 150 is discharged, and a steam nozzle 121 connected to an end of the discharge hose 120. With such configuration, water supplied to the steam generator body 150 through the water supply hose 110 is heated by the heater and then discharged through the discharge hose 120. The discharged steam is jetted into the drum 15 through the steam nozzle 121.

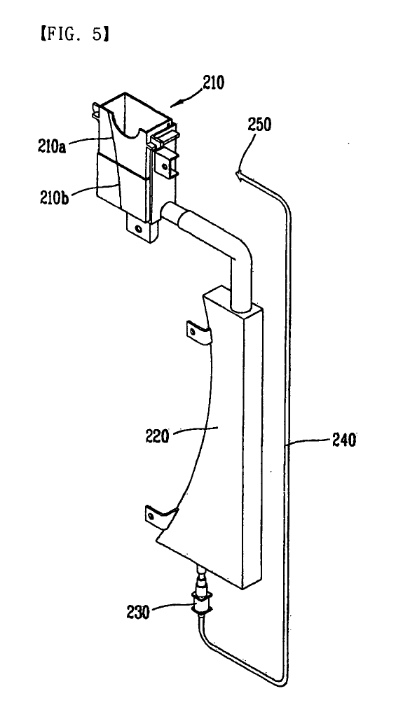

FIGS. 4 and 5 illustrate a fragrance supply device 200 for supplying fragrance into the drum of the clothes dryer according to an exemplary embodiment of the present invention.

FIG. 4 illustrates the front supporter 28 supporting the front opening of the internal drum 15 of the clothes dryer, which is viewed from the inner side of the clothes dryer, and FIG. 5 illustrates the fragrance supply device of FIG. 4.

With reference to FIGS. 4 and 5, a filter 25 is mounted at a lower side of the front supporter 28 of the clothes dryer to filter out lint included in the air discharged from the drum 15, and the fragrance supply device 200 is mounted at the side of the front supporter 28.

FIG. 5 illustrates the fragrance supply device 200 according to an exemplary embodiment of the present invention. The fragrance supply device 200 includes an injection unit 210, a chamber 220 connected with the injection unit 210, a pump 230 connected with the chamber 220, and a nozzle 250 connected with the pump 230 via a tube 240 and spraying fragrance to the interior of the drum 15.

The injection unit 210 includes a fixed member 210a and a sliding member 210b.

The fixed member 210a is fixedly inserted into the front supporter, and the sliding member 210b is slidably mounted to the fixed member 210a.

Protrusions are formed on both sides of the sliding member 210b, and guide recesses are formed on the fixed member to guide the protrusions in a sliding manner when the protrusions are inserted therein. As he sliding member 210b is slidably mixed to be inserted into the fixed member, it is inserted into the front supporter 28.

A discharge opening is formed at a lower side of the sliding member 210b, and is connected with the chamber 220 through a pipe. Thus, when the user wants to inject the fragrance liquid, he may pull the sliding member 210b out of the fixed member 210a, namely, so that the sliding member 210b can be protruded from the front supporter 28, and put the fragrance liquid into the sliding member 210b to supplement fragrance to the chamber 220.

In the present invention, in order to determine whether or not fragrance needs to be supplemented upon receiving the capacity of the fragrance liquid stored in the chamber 220, a liquid level detecting unit is provided to detect the liquid level of the fragrance liquid.

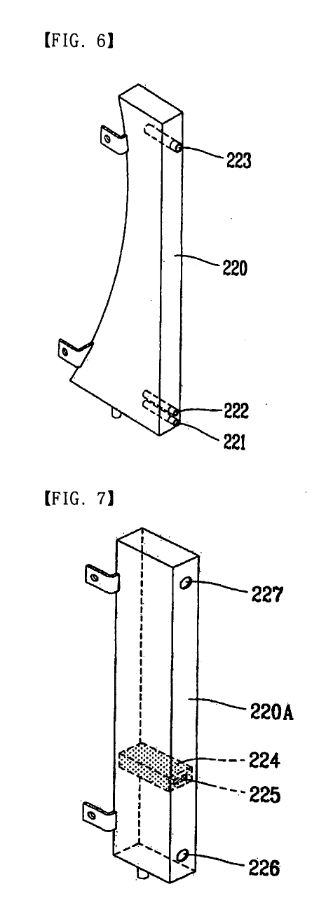

FIG. 6 illustrates the liquid level detecting unit including electrode sensors for detecting the liquid level of the fragrance liquid. By using the properties that when the electrode sensors are sunk under the fragrance liquid, they are electrically connected, while when the electrode sensors are not sunk, they are not electrically connected, whether or not the liquid level of the fragrance liquid has been up to as high as the position of the electrode sensors can be detected.

In order to detect a low liquid level of the fragrance liquid, the electrode sensors may include first and second electrode sensors 221 and 222 installed at a lower portion of the chamber 220, and in this case, the second electrode sensor 222 is installed at a position higher than that of the first electrode sensor 221.

If the liquid level of the fragrance liquid stored in the chamber 220 is determined to be low by means of the first and second electrode sensors 221 and 222, the user may supply to supplement the fragrance liquid to the chamber 220. In order to detect a high liquid level of the fragrance liquid, the electrode sensors may further include a third electrode sensor 223 installed at a certain position of an upper portion of the chamber 220. When the fragrance liquid is supplemented, whether or not the fragrance liquid supplied to the chamber 220 increases to reach a high liquid level can be determined by the third electrode sensor 223, so that the user can easily recognize a time point when the supply of the fragrance liquid must be stopped.

FIG. 7 illustrates the liquid level detecting unit including a floater 224, a magnet 225, and reed switches 226 and 227. The liquid level detecting unit includes the floater 224 ascending or descending according to the liquid level of the fragrance liquid in a chamber 220A, the magnet 225 installed on the floater 224 and generating magnetic force, and the reed switches 226 and 227 for detecting the magnetic force generated from the magnet 225 installed on the floater 224. In this embodiment, the floater 224 moves up and down in the chamber 220a according to the liquid level of the fragrance liquid. To this end, FIG. 7 shows the chamber 220A having a shape of a rectangular parallelepiped, but the present invention is not limited thereto and the chamber may have any shape so long as it is formed to be long vertically so the floater 224 can be moved up and down therein. A guide member (not shown) may be formed long within the chamber 220A to guide the movement of the floater 224 up and down.

In detail, as shown in FIG. 7, the reed switches include a first reed switch 226 installed at the lower portion of an outer side of the chamber 220A to detect a low liquid level of the fragrance liquid and a second reed switch 227 installed at an upper portion of the outer side of the chamber 220A to detect a high liquid level of the fragrance liquid. When the clothes dryer is used several times, the fragrance liquid is consumed and reduced, and accordingly, the floater 224 descends with the reduced fragrance liquid. When the descending floater 224 reaches a position corresponding to the first reed switch 226 installed at the outer side of the lower portion of the chamber 220A, the first reed switch 226 detects a magnetic force generated from the magnet 225 provided on the side of the floater 224 recognizes the position of the floater 224, and resultantly detects the liquid level of the fragrance liquid. Thus, if the liquid level of the fragrance liquid is determined to be low, the user can supply to supplement the fragrance liquid to the chamber 220A.

When the liquid level of the fragrance liquid goes up as the user supplies the fragrance liquid, the floater 224 rises. When the magnet 225 of the rising floater 224 reaches the position corresponding to the second reed switch 227, the second reed switch 227 detects it and recognizes that the liquid level of the fragrance liquid is high. Accordingly, the user can easily recognize the liquid level of the fragrance liquid.

The clothes dryer according to exemplary embodiment of the present invention may include a controller for determining a liquid level of the fragrance liquid upon receiving information regarding a liquid level detected by the liquid level detecting unit, and a display unit for displaying whether or not the liquid level of the fragrance liquid is proper upon receiving a signal from the controller.

The display unit may be formed on the control panel of the main body and may have a lamp indicating a normal liquid level, a high liquid level, and a low liquid level.

With such configuration, t he clothes dryer according to an exemplary embodiment of the present invention includes the means for detecting the liquid level of the fragrance liquid stored in the fragrance supply device, so that when the stored fragrance liquid is used up so it needs to be supplemented, the user can view an indication displayed on the control panel or the like to easily recognize it.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A clothes dryer comprising:
a drum rotatably installed within a main body;
a front supporter supporting the a front side of the drum within the main body; and
a fragrance supply device configured to supply fragrance to the interior of the drum,
wherein the fragrance supply device includes a liquid level detecting unit for detecting a liquid level of a fragrance liquid stored therein.

2. The clothes dryer of claim 1, wherein the fragrance supply device comprises:
a chamber storing a fragrance liquid;
a pump connected to the chamber; and
a nozzle connected with the pump and jetting fragrance to the interior of the drum.

3. The clothes dryer of claim 2, wherein the liquid level detecting unit comprises electrode sensors installed in the chamber.

4. The clothes dryer of claim 3, wherein the electrode sensors comprise:
a first electrode sensor installed at a lower portion of the chamber; and
a second electrode sensor installed at a position higher than the first electrode sensor, in order to detect a low liquid level of the fragrance liquid.

5. The clothes dryer of claim 4, wherein the electrode sensors further include a third electrode sensor installed at an upper portion of the chamber to detect a high liquid level of the fragrance liquid.

6. The clothes dryer of claim 2, wherein the liquid level detecting unit comprises:
a floater ascending or descending according to the liquid level of the fragrance liquid in the chamber;
a magnet installed on the floater and generating a magnetic force; and
a reed switch for detecting the magnetic force generated from the magnet installed on the floater.

7. The clothes dryer of claim 6, wherein a guiding unit is provided at the chamber to guide ascending and descending of the floater.

8. The clothes dryer of claim 6, wherein the reed switch is installed at a lower portion of an outer surface of the chamber.

9. The clothes dryer of claim 6, wherein the reed switch comprises a first reed switch installed at the lower portion of the outer surface of the chamber to detect a low liquid level of the fragrance liquid and a second reed switch installed at an upper portion of the outer surface of the chamber to detect a high liquid level of the fragrance liquid.

10. The clothes dryer of claim 1, comprising:
a controller configured to determine a liquid level of the fragrance liquid upon receiving information about a liquid level detected by the liquid level detecting unit; and
a display unit configured to display whether or not the liquid level of the fragrance liquid is proper upon receiving a signal from the controller.

11. The clothes dryer of claim 10, wherein the display unit is formed on a control panel of the main body and has a lamp for indicating a normal liquid level, a high liquid level, and a low liquid level.
